(19) United States
(12) Patent Application Publication
(10) Pub. No.: US 2015/0350309 A1
(43) Pub. Date: Dec. 3, 2015

(54) CUSTOMIZED CONTENT DELIVERY SYSTEM USING CONTENT TYPE IDENTIFIERS

(71) Applicant: ReapSo, LLC, Farmington Hills, MI (US)

(72) Inventor: William J. Wildern, IV, Farmington Hills, MI (US)

(21) Appl. No.: 14/726,865

(22) Filed: Jun. 1, 2015

Related U.S. Application Data
(60) Provisional application No. 62/006,310, filed on Jun. 2, 2014.

(51) Int. Cl. H04L 29/08; G06F 17/30

(52) U.S. Cl. CPC H04L 67/10; G06F 17/30876

(57) ABSTRACT

A method includes receiving an access code at a server, from a user device, via a first electronic computer communication link, and, in response to a determination indicating that the access code is a valid access code, selecting a selected content item from a plurality of available content items based on the access code, wherein selecting the selected content item includes selecting the selected content item based on whether the access code includes a content type identifier, which may be a special character, a content source identifier, or both, and transmitting information corresponding to the selected content item from the server to the user device via a second electronic computer communication link.

### CROSS-REFERENCE TO RELATED APPLICATIONS

This application claims the benefit of U.S. Provisional Patent Application No. 62/006,310, which was filed on Jun. 2, 2014 and is incorporated by reference in its entirety.

### BACKGROUND

The recent proliferation of internet-connected computing devices has led to the creation of many new channels by which content is delivered to consumers. While many of these channels are sponsored by advertisements, consumers have become increasingly disengaged from advertising content as a result of constant exposure to advertising. As a result, many users ignore advertisements, or employ technological measures that prevent advertisements from being displayed in conjunction with the content that they are viewing. This has led to a decrease in the efficiency of online advertising.

Targeting advertisements based on user preferences has proven effective in some content delivery channels, such as web-based advertisements. However, effective advertisement targeting requires information regarding the user. This information is, in many cases, difficult to obtain. Efforts by some advertising platforms to track user behaviors for the purpose of targeting advertisements have compounded this problem by making users reluctant to share information regarding their tastes and preferences.

### SUMMARY

The disclosure relates to customized content delivery system content type identifiers.

One aspect of the disclosed embodiments is a method that includes receiving an access code, at a server, from a user device, via a first electronic computer communication link, in response to receiving the access code, determining whether the access code is a valid access code, and in response to a determination indicating that the access code is a valid access code, selecting, by a processor of the server in response to instructions stored on a non-transitory computer readable medium of the server, a selected content item from a plurality of available content items based on the access code. Selecting the selected content item may include determining whether the access code includes a content type identifier, on a condition that the access code includes the content type identifier, selecting a plurality of candidate content items from the plurality of available content items, wherein each candidate content item from the plurality of candidate content items is associated with the content type identifier, determining whether the access code includes a content source identifier, on a condition that the access code includes the content type identifier and on a condition that the access code includes the content source identifier, selecting the selected content item from the plurality of candidate content items, wherein the selected content item is associated with the content source identifier, on a condition that the access code includes the content type identifier and on a condition that the access code omits the content source identifier, selecting the plurality of candidate content items as the selected content item, on a condition that the access code omits the content type identifier and on a condition that the access code includes the content source identifier, selecting the selected content item from the plurality of available content items, wherein the selected content item is associated with the content source identifier, and on a condition that the access code omits the content type identifier and on a condition that the access code omits the content source identifier, selecting the plurality of available content items as the selected content item. The method may include transmitting information corresponding to the selected content item from the server to the user device via a second electronic computer communication link.

Another aspect of the disclosed embodiments is a method that includes receiving an access code, at a server, from a user device, via a first electronic computer communication link, wherein the access code includes a plurality of characters, in response to receiving the access code, determining whether the access code is a valid access code, and in response to a determination indicating that the access code is a valid access code, selecting, by a processor of the server in response to instructions stored on a non-transitory computer readable medium of the server, a selected content item from a plurality of available content items based on the access code. Selecting the selected content item may include determining whether the plurality of characters includes a special character, wherein on a condition that the plurality of characters includes the special character. Selecting the selected content item may include determining whether the special character is a content type identifier, wherein on a condition that the special character is the content type identifier. Selecting the selected content item may include selecting a plurality of candidate content items from the plurality of available content items, wherein each candidate content item from the plurality of candidate content items is associated with the content type identifier, and omitting the content type identifier from the plurality of characters. Selecting the selected content item may include determining whether the plurality of characters includes a content source identifier, on a condition that the plurality of characters includes the content type identifier and on a condition that the plurality of characters includes the content source identifier, selecting the selected content item from the plurality of candidate content items, wherein the selected content item is associated with the content source identifier, on a condition that the plurality of characters includes the content type identifier and on a condition that the plurality of characters omits the content source identifier, selecting the plurality of candidate content items as the selected content item, on a condition that the plurality of characters omits the content type identifier and on a condition that the plurality of characters includes the content source identifier, selecting the selected content item from the plurality of available content items, wherein the selected content item is associated with the content source identifier, and on a condition that the plurality of characters omits the content type identifier and on a condition that the plurality of characters omits the content source identifier, selecting the plurality of available content items as the selected content item. The method may include transmitting information corresponding to the selected content item from the server to the user device via a second electronic computer communication link.

Another aspect of the disclosed embodiments is a method that includes receiving an access code, at a server, from a user device, via a first electronic computer communication link, and in response to receiving the access code, selecting, by a processor of the server in response to instructions stored on a non-transitory computer readable medium of the server, a plurality of selected content items from a plurality of available content items based on the access code. Selecting the plurality of selected content items may include on a condition that the access code includes a special character, and on a condition that the special character is a content type identifier, selecting a plurality of candidate content items from the plurality of available content items, wherein each candidate content item from the plurality of candidate content items is associated with the content type identifier, on a condition that the access code includes the content type identifier and on a condition that the access code includes a content source identifier, selecting the selected content item from the plurality of candidate content items, wherein the selected content item is associated with the content source identifier, and on a condition that the access code includes the content type identifier and on a condition that the access code omits the content source identifier, selecting the plurality of candidate content items as the selected content item. The method may include transmitting information corresponding to the selected content item from the server to the user device via a second electronic computer communication link.

### BRIEF DESCRIPTION OF THE DRAWINGS

The description herein makes reference to the accompanying drawings wherein like reference numerals refer to like parts throughout the several views, and wherein:

FIG. 1 is an illustration showing an example of an implementation of a system for delivering content to users;

FIG. 2A-2D is an illustration showing examples in which a user device receives an access code from an external object;

FIG. 3 is a flowchart showing an example of a process for delivering content items; and

FIG. 4 is a block diagram of an example of a hardware configuration for the user device.

### DETAILED DESCRIPTION

The systems and methods described herein allow for delivery of content to users using access codes that include content type identifiers. These systems and methods can provide customized digital content to a consumer/user via a user device (e.g., mobile phone, tablet, personal computer, etc.). The problems associated with conventional marketing are overcome because content is chosen based on content type identifiers that are independent of the content source.

Access to content can be conditioned upon transmission of an access code including a content type identifier from a user device to a content delivery system. The content items to which access is granted can be selected at least in part on the basis of the content type identifier. A content type identifier may be a special character, and may be located in a defined position within the access code, such as the first character position. Delivery of content to users based on access codes that include content type identifiers may be more efficient and more accurate than the delivery of content based on access codes that omit content type identifiers.

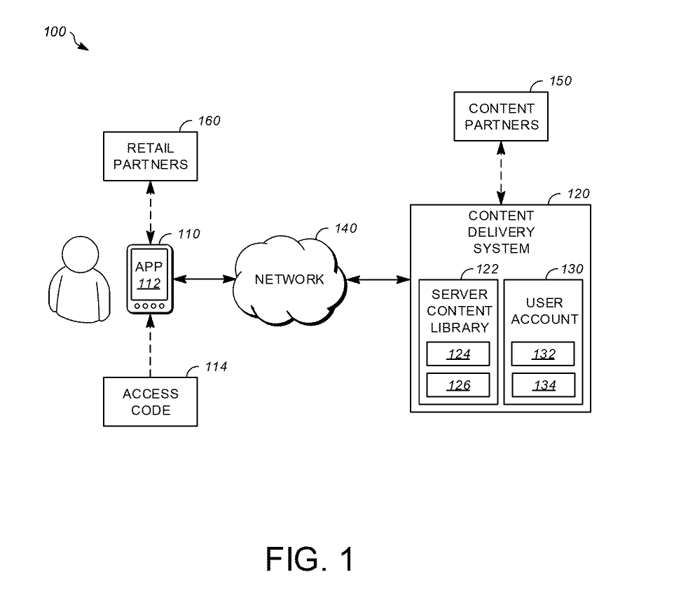

FIG. 1 is a block diagram of an example of an implementation of a system 100 for delivering content to users. A user device 110 is operable to communicate with a content delivery system 120. The content delivery system 120 can be implemented by, for example, one or more server computers. Communication between the user device 110 and the content delivery system 120, as well as other computer-based systems discussed herein, can occur via a network 140 that allows for the transmission of signals and/or data between devices that are connected to the network 140. One or more content partners 150 can be included in the system 100 and may, but need not be, in communication with and provide content to the content delivery system 120 via the network 140. One or more retail partners 160 can be included in the system 100 and may, but need not be, in communication with the content delivery system 120 via the network 140. In some instances, a partner may be both a content partner 150 and a retail partner 160.

The user device 110 can be a smart phone (computationally-enabled mobile telephone), tablet computer, laptop computer, desktop computer or other mobile computing device that can connect to the server computers of the content delivery system 120 via the network 140. The user device 110 can store and execute a client application 112. The client application 112 can be a software program that is stored in a storage medium that is accessible by the user device 110 and includes computer program instructions that, when executed by the user device 110, cause the user device 110 to perform operations that will be described further herein. In some embodiments, the client application 112 may include a user device interface, such as a browser application, configured to provide information, such as user interface elements, received from a server application executed by a server computer of the content delivery system 120.

The user device 110 can be operable to receive one or more access codes 114. Access codes 114 can each be a machine readable code in the form of signals or data in any form that can be perceived and interpreted by the user device 110. In some implementations, access codes 114 are received from a remote location, such as by transmission of signals or data via the network 140. For example, access codes 114 can be information, such as an alphanumeric string or an image (e.g., bar code, two-dimensional bar code, graphic art, photo, or logo) that can be transmitted by any suitable means for transmitting information, such as via a web page or email. In other implementations, access codes 114 are each associated with an object that is located in the same general location as the user device 110, as will be explained further herein. Access code 114 can be distributed to and obtained by the user through various channels. As examples, a user could purchase access codes 114, receive access codes 114 as a reward for the purchase of an item, receive access codes 114 as part of a promotion, receive access codes 114 from another user using the content delivery system 120 or receive access codes 114 from the operator of the content delivery system 120, receive access codes 114 via a media channel, such as a television or radio broadcast, a printed publication, a social network, or any other print or internet media channel, or receive access codes 114 at a business or live event. Access codes 114 can also be used to distribute content items regarding a person, business or other subject matter provided by the content partner 150. Access codes 114 can be associated with other users. Scanning another user's access code 114 can, in some implementations, add the other user to a “friends list.” In some embodiments, scanning an access code 114 can provide a non-user (i.e., a person who is not registered with content delivery system 120) access to the client application 112 so that the non-user can become a user.

A user may also be assigned a person access code 114 that provides information regarding a user's person personal preferences. One user's personal access code 114 may also be accessed by another user to determine the degree to which the personal preferences of the two users are compatible.

The content delivery system 120 can be implemented by one or more server computers. The one or more server computers of the content delivery system 120 can be provided with software in the form of computer program instructions that, when executed by the one or more server computers, cause the one or more server computers to perform operations that will be described further herein.

The content delivery system 120 can include a server content library 122. The server content library 122 can be used to store content items such as collectable items 124 and reward items 126 provided by, for example, the content partners 150 or the operator of the content delivery system 120. The collectable items 124 can include, but are not limited to, digital images, video, music, text and/or other information. The reward items 126 can include, but are not limited to coupons, deals, sweepstakes entries, contest entries, lottery entries, polls, trivia, or tokens that are issued by the content partners 150, and which can be redeemed for discounts, coupons, goods and/or services, a chance to win a prize, or an answer to a question. The reward items 126 can also include access codes 114.

The content delivery system 120 can store information that defines a user account 130 for each user of the content delivery system. Information identifying a user, such as a user name, email address, login and password can be associated with each user account 130. Each user account 130 can include information regarding the user, such as user preference information 134 that describes the preferences of the user. Each user account can also include a user content library 132. The user preference information 134 can include information regarding the user that is associated with the user account 130, as will be described further herein. The user content library 132 allows content items to be associated with the user account 130. For example, the user content library 132 can be defined by information identifying the content items from the server content library 122 that the user that is associated with the user account 130 is permitted to access. In some implementations, the user can view representations of the items in the user content library 132 in the form of a user interface of the client application 112. Items in the user content library 132 may, but need not be, transferred to and stored at a storage medium that is associated with the user device 110.

In some embodiments, the only identifying information stored in each user account 130 for a user can be non-personal identifying information. For example, a user may sign up for the system with only an email address with associated password and may provide a user name, gender, and postal code, if necessary without providing personal information such as name, phone number, address, etc. Thus, one benefit of the content delivery system 120 is that users may sign up and use the content delivery system 120 without specifying or providing any personal identifying information.

Access to items in the server content library 122 can be granted to the user account 130 in response to transmission of the access code 114 from the user device 110 to the content delivery system 120. The access code 114 can be transmitted from the user device 110 to the content delivery system 120 at the time that the access code 114 is received by the user device 110. In other implementations, the access code 114 may also be saved by the user device 110 and transmitted to the content delivery system 120 at a later time.

When the access code 114 is received, which may include scanning, clicking, tapping, or otherwise acquiring, at the user device 110, the access code 114 and certain information identifying the user account 130 associated with the user device 110 are transmitted to the content delivery system 120. In response to receiving the access code 114 from the user device 110, the content delivery system 120 validates the access code 114, if the access code 114 is valid, grants the user access to one or more content items from the server content library 122 by updating the user content library 132 that is associated with the user account 130, and which may be associated with the user device 110.

When an access code (e.g., access code 114) is received at the user device 110 in association with a non-user, the access code can be transmitted to the content delivery system 120. In response to receiving an access code 114 from a user device 110 by the non-user, the non-user can be directed to download the client application 112 so that the non-user can become a user.

The content delivery system can validate the access code 114 (i.e. determine whether the user is authorized to use the access code) based on one or more validation criteria. The validation criteria can include, for example, whether the user has previously submitted the same access code 114 to the content delivery system 120, whether the user has previously submitted the same access code 114 to the content delivery system 120 within a predetermined time period, or whether a different user has previously submitted the same access code 114 to the content delivery system 120. By applying validation criteria, the access codes 114 can be configured to be utilized in multiple ways, such as access codes 114 that allow one usage only, access codes 114 that allow one usage per user, and access codes 114 that can be used multiple times by the same user subject to the expiration of a lock-out period.

In one implementation, access to one of the content items is only granted upon transmission of certain access codes 114 to the content delivery system 120. Access to the content items can be granted on a one-to-one basis with respect to transmission of a certain access code 114 from the user device 110 to the content delivery system 120.

Access to content items can be traded among users. For example, the content delivery system 120 can implement an exchange system in which users can trade their respective rights to access content items. For example, the user can trade its right to access a first content item for the right to access a second content item, and as a result of the trade, the user no longer possesses the right to access the first content item upon receiving access to the second content item. The second item may be one that was forfeited by another user or may be a content item that was provided by a content partner 150 directly to the exchange system. The user may also be able to trade the first content item for one or more access codes 114 rather than a new content item. The user may also be able to trade one or more access codes 114 for a content item. The user may also gift one or more access codes 114, or its right to access a content item to another user and receive nothing in return.

The network 140 can include multiple networks of varying types, including LANs, WANs, and the internet in any combination. Wired and/or wireless communications protocols can be used.

The content partners 150 can include third parties that are not associated with the user of the user device 110 or the operator of the content delivery system 120. At least some of the collectable items 124 and the reward items 126 that are included in the server content library 122 of the content delivery system 120 are provided by the content partners 150. In some implementations, which will be explained herein, the content partners 150 must satisfy one or more conditions in order to be permitted to add content items to the server content library 122. In one example, the content partners 150 are businesses that pay a fee to the operator of the content delivery system 120 for the right to add collectible content 124 and reward content 126 items to the server content library 122. In another example, content partners 150 are businesses that pay a fee to the operator of the content delivery system 120 for each reward content 126 item that is acquired by a user and each reward content 126 item that is activated by a user. In another example, content partners 150 are users, businesses or individuals who own content items and submit those content items to the operator of the content delivery system 120 for approval to add the items to the server content library 122. In some implementations, a voting mechanism is implemented by the content delivery system 120, which allows users to vote as to whether or not new content items are added to the server content library 122. In such a system, new content items can be added to the server content library 122 in response to receiving at least a threshold number of votes from users of the content delivery system 120.

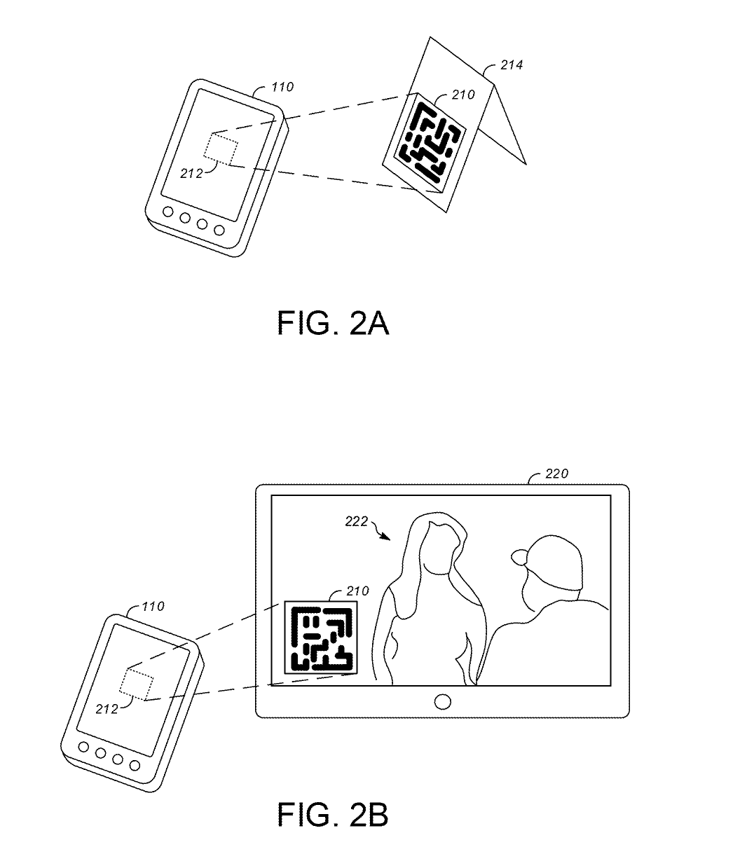

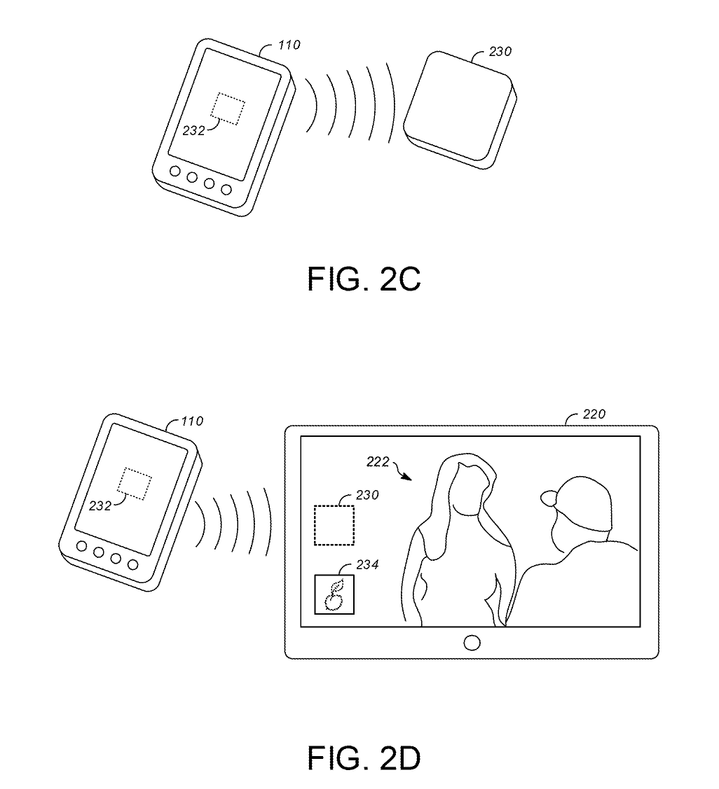

FIGS. 2A-2D are illustrations showing examples in which the user device 110 receives the access code 114 via an external object that is located in the same general location as the user device 110. The external object can be any device or structure capable of displaying, transmitting, or otherwise making the machine readable code available to the user device 110. These devices and structures are sometimes referred to herein as tags.

In FIGS. 2A-2B, an access code 114 is encoded in a symbolic tag 210 that can be scanned by an optical sensor 212 that is associated with the user device 110. The symbolic tag 210 can be in a form that can be visually perceived by the user. As one example, the symbolic tag 210 can be in the form of a barcode in any now known or later developed format, including linear barcodes, such as UPC barcodes, and matrix barcodes, such as QR codes. In another example, the access code 114 can be in the form of a digital image, company logo, or other graphic design. In implementations where the symbolic tag is a barcode, the optical sensor 212 can be a barcode reader, a camera, or other device that is able to scan barcodes. In implementations where the symbolic tag is an image, such as a logo, the optical sensor 212 can capture the image so that the client application 112 or the content delivery system 120 can retrieve an access code associated with the image.

In some implementations, the symbolic tag 210 can be printed or otherwise displayed on any manner of static display 214 (FIG. 2A), examples of which include but are not limited to signs, posters, flyers, magazines, printed advertisements, menus, table tents, confetti, newspapers, billboards, and business cards. In addition, when the access code 114 that is encoded in the symbolic tag 210 on the static display 214 is transmitted to the content delivery system 120, validation of the access code 114 can include applying validation criteria by transmitting geolocation information from the user device 110 to the content delivery system 120 and determining whether the symbolic tag 210 was scanned by the user device 110 at a location that corresponds to the location of the static display 214, wherein the access code 114 is validated if scanned at a location corresponding to the static display 214, and is not validated if it was scanned at a location that does not correspond to the static display 214, thereby preventing an unauthorized party from copying and redistributing the symbolic tag 210.

In some implementations, when the access code 114 that is encoded in the symbolic tag 210 on the static display 214 is transmitted to the content delivery system 120, a reward content item, if provided to the user, may be able to be redeemed immediately or may contain a redemption delay feature such that it cannot be redeemed for a certain period of time following the receipt of the access code 114 by the one or more server computers.

In other implementations, the symbolic tag 210 can be transmitted by presenting the symbolic tag 210 on a changeable display, such as a video image produced by a display screen 220, such as a television or a computer monitor. For example, the symbolic tag 210 can be superimposed on video content 222, such as an advertisement that is sponsored by one of the content partners 150. While the advertisement or other video content 222 is being displayed on the display screen 220, the symbolic tag 210 can be scanned by the optical sensor 212, or otherwise input into the user device 110. In one example, such as a scheduled or live broadcast, when the access code 114 that is encoded in the symbolic tag 210 from the display screen 220 is transmitted to the content delivery system 120, validation of the access code 114 can include applying validation criteria by determining whether the symbolic tag 210 was scanned by the user device 110 during the time period in which the advertisement or other video content 222 was scheduled for display on the display screen 220, wherein the access code 114 is validated if scanned during the appropriate time period, and is not validated if it was not scanned during the appropriate time period, thereby preventing an unauthorized party from copying and redistributing the symbolic tag 210. To allow validation based on the time at which the access code 114 was received at the user device 110, the user device 110 can transmit a time value to the content delivery system 120 along with the access code 114. As long as the time value occurs within a predetermined time period (e.g., one minute) after transmission of the video content, the access code can be validated. In this example, the content partners 150 incentivize users to view the advertisement or other video content 222 during the time scheduled, and receive confirmation that the advertisement or other video content 222 has been viewed, via transmission of the access code 114 to the content delivery system 120 by the user.

In another implementation, such as a recorded broadcast, when the access code 114 that is encoded in the symbolic tag 210, which may be an image or text, from the display screen 220 is transmitted to the content delivery system 120, validation of the access code 114 can include applying validation criteria by determining whether the symbolic tag 210 was scanned by the user device 110 during an acceptable time period after the scheduled broadcast in which the advertisement or other video content 222 was scheduled for display on the display screen 220. In this implementation, the access code 114 can be validated if the time value occurs within a predetermined time value (e.g., one week) after transmission of the video content. Thus, the access code is validated if scanned during the predetermined time period after the scheduled broadcast, and is not validated if it was scanned after the predetermined time period, thereby preventing an unauthorized party from copying and redistributing the symbolic tag 210 after an acceptable time period. To allow validation based on the time at which the access code 114 was received at the user device 110, the user device 110 can transmit a time value to the content delivery system 120 along with the access code 114. In this example, the content partners 150 can incentivize users to view the advertisement or other video content 222 during the predetermined time period after the scheduled broadcast, and receive confirmation that the advertisement or other video content 222 has been viewed, via transmission of the access code 114 to the content delivery system 120 by the user.

In FIGS. 2C-2D, the access code 114 is encoded in the form of signals and/or data that are wirelessly transmitted from a wireless tag 230. The signals and/or data that are wirelessly transmitted from the wireless tag 230 can be received using a wireless signal receiver 232 that is associated with the user device 110.

The wireless tag 230 can be any device suitable to transmit the machine-readable code using any protocol or format now known or later developed, such as Radio-Frequency Identification (RFID), Near Field Communication (NFC) as defined by the ISO/IEC 18092 standard and the ECMA-340 standard, or wireless networking technologies such as the Bluetooth and 802.11 standards. The wireless signal receiver 232 of the user device 110 can receive the signals and/or data transmitted from the wireless tag using an antenna or an inductor in communication with wireless receiver circuitry of the appropriate type.

The wireless tag 230 can, in some implementations, be incorporated into the same type of objects to which the symbolic tag 210 can be applied (FIG. 2C). For example, a wireless tag 230 in the form of a passive NFC tag could be attached to a sign, poster, table tent or other article. In other examples, the wireless tag could be transmitted to the user device 110 from an external electronic device, such as a smart phone or a television.

As another example, the wireless tag 230 can be associated with a display screen 220 (FIG. 2D), and can be operable to transmit the access code 114 to the wireless signal receiver 232 of the user device 110 during the time period in which the advertisement or other video content 222 is presented on the display screen 220. An icon 234 can be superimposed on the advertisement or other video content 222 to indicate to the user that the wireless tag 230 is ready to transmit and/or transmitting the access code 114 that corresponds to the advertisement or other video content 222.

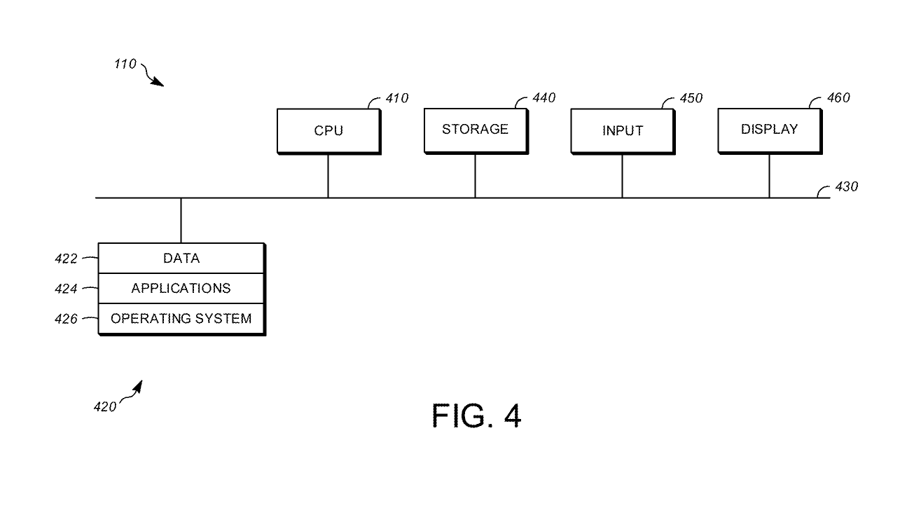

Although not shown in FIGS. 4A-4D, in some implementations, the user device 110 may receive an access code in response to input, such as user input. For example, a user of the user device 110 may input an access code by typing, tapping, gesturing, or speaking into an input unit of the user device.

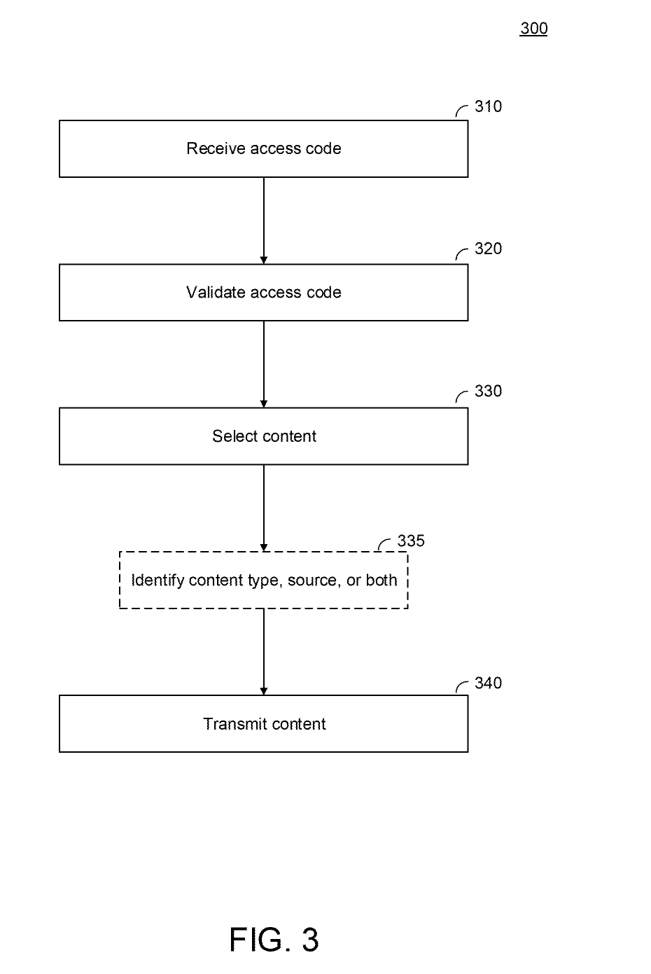

FIG. 3 is a flowchart showing an example of a process 300 for delivering content items. In some embodiments, the operations described in connection with the process 300 can be performed at the user device 110. The process 300 can be embodied in the form of computer executable program instructions that are stored on a storage medium or storage device, which can, in some examples, be a non-transitory computer-readable storage medium or storage device. When executed by a processor, the instructions cause the processor to perform the operations described herein with reference to the process 300.

In some implementations, delivering content items 300 may include receiving an access code at 310, validating the access code at 320, selecting content at 330, transmitting the content at 340, or a combination thereof.

In some implementations, an access code may be received at 310. For example, an access code, such as the access code 114 shown in FIG. 1, may be received by a server, such as a server of the content delivery 120 shown in FIG. 1, from a user device, such as the user device 110 shown in FIG. 1, via an electronic computer communication link, such as via the network 140 shown in FIG. 1.

In some implementations, the access code may be validated at 320. In some embodiments, the access code may be validated at 320 based on one or more validation criteria. As discussed previously, the validation criteria can include, for example, whether the user has previously submitted the same access code to the content delivery system 120, whether the user has previously submitted the same access code to the content delivery system 120 within a predetermined time period, or whether a different user has previously submitted the same access code to the content delivery system 120.

In some implementations, an access code may be represented as a character string, which may include letters, numbers, character symbols, such as an exclamation mark or a question mark, or a combination thereof. In an example, an access code may be represented as a character string that may appear to be random to a human observer. For example, the character string “x4DffHJ89” may be an access code corresponding to a company called “XYZCorp”. In another example, an access code may be represented as a character string that may appear intelligible to a human observer. For example, the character string “XYZCorp” may be an access code corresponding to the company called XYZCorp.

In some implementations, an access code may include one or more parts or portions, such as a portion including a content source identifier and a portion including a content type identifier. For example, the access code “?XYZCorp” includes a first portion including a content type identifier, “?”, and a second portion including a content source identifier, “XYZCorp”. In another example, the access code “XYZCorp!!” includes a first portion including a content source identifier, “XYZCorp”, and a second portion including a content type identifier, “!!”. In some embodiments, an access code may include a third portion. For example, the acces code “XYZ?!Corp” includes a first portion, “XYZ”, a second portion including a content type identifier, “?!”, and a third portion “corp”.

A content source identifier may be source specific and may indicate a source or subject matter represented by the access code, such as a person, a brand, a genre, a business, or other subject matter provided by a content partner. For example, the available content provided by a company called “XYZCorp” may be identified by an access code including the content source identifier “XYZCorp”. In some implementations, the content source identifier may be omitted from an access code.

A content type identifier may indicate a content type or topic, independent of the content source. In some implementations, a content type identifier may be implemented using a special character, such as a question mark (?), an exclamation mark (!), an asterisk (*), a currency sign, such as a dollar sign ($), or any other special character. For example, an access code may include the question mark (?) content type identifier, which may indicate content relating to inquiries, such as polling, voting, or trivia. In another example, an access code may include the exclamation mark (!) content type identifier, which may indicate content relating to exciting events, such as a contest, sweepstakes, or other means of winning a prize. In another example, an access code may include the dollar sign ($) content type identifier, which may indicate content relating to saving money, such as a coupon, deal, perk or other value enhancing rewards. In another example, an access code may include the asterisk (*) content type identifier, which may indicate content relating to famous people or groups, such as actors, actresses, celebrities, public officials, bands, artists, and other well-known or aspiring people or groups. In some implementations, the content type identifier may be omitted from an access code.

In some implementations, content items may be selected at 330. In an implementation, the content items may be selected based at least in part on the access code 114, such as by selecting one or more content items from a set of content items that are associated with one or more of the content partners 150 that are associated with the access code 114.

In some implementations, selecting the content may include determining whether the access code includes a content type identifier, a content source identifier, or both at 335. For example, a first portion of the access code may include a content type identifier, and a second portion of the access code may include a content source identifier. In another example, the access code may include a content type identifier and may omit the content source identifier. In another example, the access code may include a content source identifier and may omit the content type identifier. In another example, and access code may omit the content type identifier and the content source identifier.

In some embodiments, the access code may be evaluated to determine the type of character in a defined position in the access code, such as the first, or leftmost, position. In some embodiments, the first character in the access code may be a special character, such as *, ?, !, or $, which may indicate that the access code includes a content type identifier. In some embodiments, the first character in the access code may be an alphanumeric character, which may include a letter of the alphabet in upper or lower case, such as A-Z, a-z, or a number, such as 0-9. For example, the first character in an access code may be a question mark (?) and may be identified as a content type identifier. In another example, the first character in an access code may be the letter “A”, and may be identified as a content source identifier, which may indicate that the access code omits a content type identifier. Although the defined content type identifier position is described herein as the first character position in the access code, another defined character position, such as the last, or rightmost, character position in the access code may be used. In FIG. 3, determining whether the access code includes a content type identifier, a content source identifier, or both at 335 is shown using a broken line to indicate that, in some implementations, determining whether the access code includes a content type identifier, a content source identifier, or both at 335 may be omitted. Alphanumeric characters are described herein in relation to the English alphabet for simplicity; however, any alphabet, or character coding scheme, that distinguishes special characters may be used.

In some implementations, an access code may include a special character in a position other than the identified content type identifier position in the access code, and the special character may be identified as the content source identifier, or a portion thereof. For example, the identified content type identifier position may be the first character position in the access code, the first character position in the access code may include an alphanumeric character, such as the letter “A”, the last character position in the access code may include an exclamation mark (!), the exclamation mark (!) may be identified as part of the content source identifier, and the access code may be identified as omitting a content type identifier.

In an example, the access code “XYZCorp” may be identified as including a content source identifier, “XYZCorp”, omitting a content type identifier, and the content selected at 330 may include content associated with or provided by XYZCorp. Content unrelated to XYZCorp may be omitted.

In another example, the access code “!XYZCorp” may be identified as including a content type identifier, “!”, and a content source identifier, “XYZCorp”, and the content selected at 330 may include content related to a contest associated with or provided by XYZCorp. Content unrelated to the “!” content type identifier and XYZCorp may be omitted.

In another example, the access code “?XYZCorp” may be identified as including a content type identifier, “?”, and a content source identifier, “XYZCorp”, and the content selected at 330 may include content related to a trivia campaign associated with or provided by XYZCorp. Content unrelated to the “?” content type identifier and XYZCorp may be omitted.

In another example, the access code “$XYZCorp” may be identified as including a content type identifier, “$”, and a content source identifier, “XYZCorp”, and the content selected at 330 may include content related to a discount offer associated with or provided by XYZCorp. Content unrelated to the “$” content type identifier and XYZCorp may be omitted.

In another example, the access code “*XYZCorp” may be identified as including a content type identifier, “*”, and a content source identifier, “XYZCorp”, and the content selected at 330 may include content related to a photo of a mascot associated with or provided by XYZCorp. Content unrelated to the “*” content type identifier and XYZCorp may be omitted.

Although the special characters “?”, “!”, “$”, and “*” are described as content type identifiers herein, any special character may be used as a content type identifier.

In some implementations, one or more of the content items available to the content delivery system 120 may be associated with one or more content type identifiers. For example, a content item may be coupon, and may be associated with the dollar sign ($) content type identifier, indicating that the coupon is related to the financial content type. In another example, content items showing images of mascots used by a company may be associated with the question mark (?) content type identifier, which may indicate that the mascot images are related to the trivia content type. In another example, content items showing images of mascots used by a company may be associated with the asterisk (*) content type identifier, which may indicate that the mascot images are related to content relating to famous people or groups. In another example, content items showing images of mascots used by a company may be associated with the asterisk (*) content type identifier and the question mark (?) content type identifier, which may indicate that the mascot images are related inquiries and to famous people or groups.

In some implementations, selecting content at 330 based on an access code that includes a content type identifier may be more efficient than selecting content based on an access code that omits a content type identifier. For example, selecting content at 330 based on an access code that includes a content type identifier may utilize fewer resources than selecting content based on an access code that omits a content type identifier.

In an example, the content delivery system 120 may evaluate many content items to select content at 330. Evaluating each item may utilize resources. The resources utilized for selecting content at 330 based on an access code that omits a content type identifier may be proportional to the number, or cardinality, of content items available to the content delivery system 120. To select content at 330 based on an access code that includes a content type identifier, the content delivery system 120 may omit or ignore content items associated with a different content type identifier, content items unassociated with a content type identifier, or both. The resources utilized for selecting content at 330 based on an access code that includes a content type identifier may be proportional to the number, or cardinality, of content items associated with the content type identifier.

In some implementations, selecting content at 330 based on an access code that includes a content type identifier may be more effective than selecting content based on an access code that omits a content type identifier. For example, selecting content at 330 based on an access code that includes a content type identifier may identify a more narrowly tailored set of content than selecting content based on an access code that omits a content type identifier.

In operation 340, information corresponding to the one or more content items that were selected in operation 330 may be transmitted to the user device 110 by the content delivery system 120. For example, the content delivery system 120 can transmit one or both of the collectable item award message 610 and the reward item award message 620 to the user device 110. The user content library 132 can also be updated to reflect the user's access to the newly awarded content items.

FIG. 4 is a block diagram of an example of a hardware configuration for the user device 110. Other computers and/or devices described herein can be implemented using a similar configuration.

The CPU 410 of the user device 110 can be a conventional central processing unit. Alternatively, the CPU 410 can be any other type of device, or multiple devices, capable of manipulating or processing information now-existing or hereafter developed. Although the disclosed examples can be practiced with a single processor as shown, e.g. CPU 410, advantages in speed and efficiency can be achieved using more than one processor.

The user device 110 can include memory 420, such as a random access memory device (RAM). Any other suitable type of storage device can be used as the memory 420. The memory 420 can include code and data 422, one or more application programs 424, and an operating system 426, all of which can be accessed by the CPU 410 using a bus 430. The application programs 424 can include programs that permit the CPU 410 to perform the methods described here.

A storage device 440 can be optionally provided in the form of any suitable computer readable medium, such as a hard disc drive, a memory device, a flash drive or an optical drive. One or more input devices 450, such as a keyboard, a mouse, or a gesture sensitive input device, receive user inputs and can output signals or data indicative of the user inputs to the CPU 410. One or more output devices can be provided, such as a display device 460. The display device 460, such as a liquid crystal display (LCD) or a cathode-ray tube (CRT), allows output to be presented to a user, for example, in response to receiving a video signal.

Although the CPU 410 and the memory 420 of the user device 110 are depicted as being integrated into a single unit, other configurations can be utilized. The operations of the CPU 410 can be distributed across multiple machines (each machine having one or more of processors) which can be coupled directly or across a local area or other network. The memory 420 can be distributed across multiple machines such as network-based memory or memory in multiple machines performing the operations of the user device 110. Although depicted here as a single bus, the bus 430 of the user device 110 can be composed of multiple buses. Further, the storage device 440 can be directly coupled to the other components of the user device 110 or can be accessed via a network and can comprise a single integrated unit such as a memory card or multiple units such as multiple memory cards. The user device 110 can thus be implemented in a wide variety of configurations.

The computers and/or devices described herein (and the algorithms, methods, instructions etc. stored thereon and/or executed thereby) can be realized in hardware including, for example, intellectual property (IP) cores, application-specific integrated circuits (ASICs), programmable logic arrays, optical processors, programmable logic controllers, microcode, firmware, microcontrollers, servers, microprocessors, digital signal processors or any other suitable circuit. In the claims, the term “processor” should be understood as encompassing any the foregoing, either singly or in combination. The terms “signal” and “data” are used interchangeably.

In some implementations, operations described herein as being performed by a single computer or device can be performed by multiple computers and/or devices. In other implementations, the operations described herein as being performed by multiple computers and/or devices can be performed by a single computer or device. Although illustrated for simplicity as unitary machines, it is understood that the computers and devices shown and described herein are not necessarily implemented using a single processor, or a single physical machine. Moreover, although features may be described above or claimed as acting in certain combinations, one or more features of a combination can in some cases be excised from the combination, and the combination may be directed to a sub-combination or variation of a sub-combination.

In another example, the computers and or devices described herein can be implemented using special purpose computers/processors with a computer program that, when executed, carries out any of the respective methods, algorithms and/or instructions described herein. In addition or alternatively, for example, special purpose computers/processors can be utilized which can contain specialized hardware for carrying out any of the methods, algorithms, or instructions described herein.

Further, all or a portion of the embodiments of the disclosure can take the form of a computer program product accessible from, for example, a storage device or storage medium such as a non-transitory computer-usable or computer-readable medium. A storage device or storage medium can be any device that can, for example, tangibly contain, store, communicate, or transport the program for use by or in connection with any processor. The storage device or storage medium can be, for example, an electronic device, magnetic device, optical device, electromagnetic device, or a semiconductor device. Other suitable devices and mediums are also available.

While this disclosure includes what is presently considered to be the most practical and preferred embodiments, it is to be understood that the disclosure is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A method for use in electronic communication, the method comprising:
receiving an access code, at a server, from a user device, via a first electronic computer communication link;
in response to receiving the access code, determining whether the access code is a valid access code; and
in response to a determination indicating that the access code is a valid access code, selecting, by a processor of the server in response to instructions stored on a non-transitory computer readable medium of the server, a selected content item from a plurality of available content items based on the access code, wherein selecting the selected content item includes:
determining whether the access code includes a content type identifier,
on a condition that the access code includes the content type identifier, selecting a plurality of candidate content items from the plurality of available content items, wherein each candidate content item from the plurality of candidate content items is associated with the content type identifier,
determining whether the access code includes a content source identifier,
on a condition that the access code includes the content type identifier and on a condition that the access code includes the content source identifier, selecting the selected content item from the plurality of candidate content items, wherein the selected content item is associated with the content source identifier,
on a condition that the access code includes the content type identifier and on a condition that the access code omits the content source identifier, selecting the plurality of candidate content items as the selected content item,
on a condition that the access code omits the content type identifier and on a condition that the access code includes the content source identifier, selecting the selected content item from the plurality of available content items, wherein the selected content item is associated with the content source identifier,
on a condition that the access code omits the content type identifier and on a condition that the access code omits the content source identifier, selecting the plurality of available content items as the selected content item, and
transmitting information corresponding to the selected content item from the server to the user device via a second electronic computer communication link.

2. The method of claim 1, wherein the access code includes a plurality of characters, and wherein determining whether the access code includes a content type identifier includes:
on a condition that a defined content type identifier character position is unavailable, for each character from the plurality of characters, determining whether the character is a content type identifier; and
on a condition that the defined content type identifier character position is available, identifying the defined content type identifier character position, identifying a character from the plurality of characters corresponding to the defined content type identifier character position, and determining whether the character is a content type identifier.

3. The method of claim 2, wherein the defined content type identifier character position is a leftmost character position in the access code.

4. The method of claim 2, wherein the defined content type identifier character position is a rightmost character position in the access code.

5. The method of claim 2, wherein selecting the selected content item includes:
in response to determining that the access code includes the content type identifier, determining whether the access code includes another content type identifier.

6. The method of claim 2, wherein determining whether the character is a content type identifier includes:
determining whether the character is included in a defined plurality of content type identifiers.

7. The method of claim 6, wherein determining whether the character is included in the defined plurality of content type identifiers includes:
determining whether the character is a special character, wherein determining whether the character is a special character includes determining that the character is a special character on a condition that the character is a character other than an alphanumeric character.

8. The method of claim 7, wherein determining whether the character is a special character includes:
determining that the character is a special character on a condition that the character is a question mark, an exclamation mark, a currency sign, or an asterisk.

9. The method of claim 1, wherein the selected content item includes a plurality of selected content items.

10. The method of claim 1, wherein selecting the plurality of candidate content items includes:
on a condition that the content type identifier indicates a question mark, selecting the plurality of candidate content items such that each candidate content item from the plurality of candidate content items is associated with an inquiry content type;
on a condition that the content type identifier indicates an exclamation mark, selecting the plurality of candidate content items such that each candidate content item from the plurality of candidate content items is associated with an event content type;
on a condition that the content type identifier indicates a currency sign, selecting the plurality of candidate content items such that each candidate content item from the plurality of candidate content items is associated with a financial content type; and
on a condition that the content type identifier indicates an asterisk, selecting the plurality of candidate content items such that each candidate content item from the plurality of candidate content items is associated with a fame content type.

11. The method of claim 1, wherein selecting the plurality of candidate content items includes:
on a condition that the content type identifier indicates a question mark, selecting the plurality of candidate content items such that each candidate content item from the plurality of candidate content items is an inquiry content item, a poll content item, a voting content item, or a trivia content item;
on a condition that the content type identifier indicates an exclamation mark, selecting the plurality of candidate content items such that each candidate content item from the plurality of candidate content items is an event content item, a contest content item, a sweepstakes content item, or a content item related to winning a prize;
on a condition that the content type identifier indicates a currency sign, selecting the plurality of candidate content items such that each candidate content item from the plurality of candidate content items is a coupon content item, a deal content item, a perk content item, a reward content item, or a content item related to saving money; and
on a condition that the content type identifier indicates an asterisk, selecting the plurality of candidate content items such that each candidate content item from the plurality of candidate content items is related to a famous person, a famous group, an actor, an actresses, a celebrity, a public official, a bands, or an artists.

12. The method of claim 11, wherein the famous person is fictional.

13. The method of claim 1, wherein the first electronic computer communication link is the second electronic computer communication link.

14. The method of claim 1, wherein the access code includes the content source identifier, wherein the content source identifier is associated with a content partner, and wherein the selected content item is associated with the content partner.

15. A method for use in electronic communication, the method comprising:
receiving an access code, at a server, from a user device, via a first electronic computer communication link, wherein the access code includes a plurality of characters;
in response to receiving the access code, determining whether the access code is a valid access code; and
in response to a determination indicating that the access code is a valid access code, selecting, by a processor of the server in response to instructions stored on a non-transitory computer readable medium of the server, a selected content item from a plurality of available content items based on the access code, wherein selecting the selected content item includes:
determining whether the plurality of characters includes a special character, wherein on a condition that the plurality of characters includes the special character, selecting the selected content item includes:
determining whether the special character is a content type identifier, wherein on a condition that the special character is the content type identifier, selecting the selected content item includes:
selecting a plurality of candidate content items from the plurality of available content items, wherein each candidate content item from the plurality of candidate content items is associated with the content type identifier, and
omitting the content type identifier from the plurality of characters,
determining whether the plurality of characters includes a content source identifier;
on a condition that the plurality of characters includes the content type identifier and on a condition that the plurality of characters includes the content source identifier, selecting the selected content item from the plurality of candidate content items, wherein the selected content item is associated with the content source identifier,
on a condition that the plurality of characters includes the content type identifier and on a condition that the plurality of characters omits the content source identifier, selecting the plurality of candidate content items as the selected content item,
on a condition that the plurality of characters omits the content type identifier and on a condition that the plurality of characters includes the content source identifier, selecting the selected content item from the plurality of available content items, wherein the selected content item is associated with the content source identifier,
on a condition that the plurality of characters omits the content type identifier and on a condition that the plurality of characters omits the content source identifier, selecting the plurality of available content items as the selected content item, and
transmitting information corresponding to the selected content item from the server to the user device via a second electronic computer communication link.

16. The method of claim 15, wherein determining whether the plurality of characters includes the content type identifier includes:
on a condition that a defined content type identifier character position is unavailable, for each character from the plurality of characters, determining whether the character is the content type identifier; and
on a condition that the defined content type identifier character position is available, identifying the defined content type identifier character position, identifying a character from the plurality of characters corresponding to the defined content type identifier character position, and determining whether the character is the content type identifier.

17. The method of claim 16, wherein the defined content type identifier character position is a leftmost character position in the access code, or a rightmost character position in the access code.

18. The method of claim 16, wherein determining whether the character is a content type identifier includes:
determining whether the character is a special character.

19. The method of claim 18, wherein determining whether the character is a special character includes:
determining that the character is a special character on a condition that the character is a question mark, an exclamation mark, a currency sign, or an asterisk.

20. A method for use in electronic communication, the method comprising:
receiving an access code, at a server, from a user device, via a first electronic computer communication link; and
in response to receiving the access code, selecting, by a processor of the server in response to instructions stored on a non-transitory computer readable medium of the server, a plurality of selected content items from a plurality of available content items based on the access code, wherein selecting the plurality of selected content items includes:
on a condition that the access code includes a special character, and on a condition that the special character is a content type identifier, selecting a plurality of candidate content items from the plurality of available content items, wherein each candidate content item from the plurality of candidate content items is associated with the content type identifier,
on a condition that the access code includes the content type identifier and on a condition that the access code includes a content source identifier, selecting the selected content item from the plurality of candidate content items, wherein the selected content item is associated with the content source identifier,
on a condition that the access code includes the content type identifier and on a condition that the access code omits the content source identifier, selecting the plurality of candidate content items as the selected content item, and
transmitting information corresponding to the selected content item from the server to the user device via a second electronic computer communication link.
